(19) United States
(12) Patent Application Publication
(10) Pub. No.: US 2002/0007381 A1
(43) Pub. Date: Jan. 17, 2002

(54) Method and configuration for assigning an object to at least one class

(76) Inventor: Thomas Bruckner, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/821,967

(22) Filed: Mar. 30, 2001

Related U.S. Application Data
(63) Continuation of application No. PCT/DE99/02929, filed on Sep. 14, 1999.

(30) Foreign Application Priority Data
Sep. 30, 1998 (DE) 198 44 948.8

(51) Int. Cl. G06F 17/21; G06F 17/30

(52) U.S. Cl. 707/531; 707/103 R; 707/530; 707/5

(57) ABSTRACT

An object is assigned to at least one class of a set of classes by determining for the object a membership criterion to each class. In this process, class-dependent threshold values are determined for the assignment by optimizing an evaluation criterion under prescribed secondary conditions. A comparison of the membership criterion with the threshold values of the classes yields the appropriate assignment of the object to at least one class.

### CROSS-REFERENCE TO RELATED APPLICATION

This application is a continuation of copending International Application No. PCT/DE99/02929, filed Sep. 14, 1999, which designated the United States.

### BACKGROUND OF THE INVENTION

1. Field of the Invention

The invention relates to a method and a configuration for assigning an object to at least one class from a set of prescribed classes with a computer.

A method and a configuration for classifying a text are known from WO97/38382, “Verfahren zur automatischen Klassifikation eines auf einem Dokument aufgebrachten Textes nach dessen Transformation in digitale Daten,” [Process For Automatic Classification of Printed Text On A Document After Its Transformation Into Digital Data.] In the classification, an object is assigned to one or more classes (multi-classification system) by determining a membership criterion for the object and comparing it to an associated threshold value for each class. If the membership criterion for the respective class is higher than the threshold value of this class, the object is assigned to the class. This classification is inaccurate because the threshold values of all classes are predetermined globally.

Moreover, a method for solving a system of linear equations is known from http://www.wior.uni-karlsruhe.de/Bibliothek/Software_for_OR/Linear_Programming/pub /lp_solve/index.html, Sep. 28, 1998; hereinafter referred to as “www.wior.uni-karlsruhe.de”

### SUMMARY OF THE INVENTION

It is accordingly an object of the invention to provide a method and configuration for assigning an object to at least one class that overcomes the hereinafore-mentioned disadvantages of the heretofore-known devices of this general type and that renders a classification possible. According to the invention, specific threshold values are automatically determined for a plurality of classes.

With the foregoing and other objects in view, there is provided, in accordance with the invention, a method for assigning an object to at least one class from a set of prescribed classes with a computer. The method includes determining a membership criterion of an object for each class. The next step is calculating a threshold value for each class from a set of prescribed classes by optimizing an evaluation criterion under prescribed secondary conditions. The next step is assigning the object to a class from the set of prescribed classes if the membership criterion is above the threshold value of the class. The next is not assigning the object to a class from the set of prescribed classes if the membership criterion is below the threshold value of the class.

With the objects of the invention in view, there is also provided a method for classifying text by assigning an object to at least one class from a set of prescribed classes with a computer. The method includes determining a membership criterion of an object for each class. The next step is calculating a threshold value for each class from a set of prescribed classes by optimizing an evaluation criterion under prescribed secondary conditions. The next step is assigning the object to a class from the set of prescribed classes if the membership criterion is above the threshold value of the class. The next step is not assigning the object to a class from the set of prescribed classes if the membership criterion is below the threshold value of the class. In accordance with another mode of the invention, the classes in the text classification are domains.

With the objects of the invention in view, there is also provided a configuration for assigning an object to at least one class from a set of prescribed classes. The configuration includes a processor unit. The processor unit determines a membership criterion of an object of a class for each class of a set of classes. The processor unit also calculates a threshold value for each class of the set of classes by optimizing an evaluation criterion under prescribed secondary conditions. The processor unit assigns the object to a class from the set of prescribed classes if the membership criterion is above the threshold value of the class. The processor unit does not assign the object to a class from the set of classes if the membership criterion is below the threshold value of the class.

In order to achieve the object of the invention, a method is specified for assigning an object to at least one class from a set of prescribed classes with the assistance of a computer. In the method, a membership criterion of an object to a class is determined for each class. A threshold value is calculated for each class from the set of classes by optimizing an evaluation criterion under prescribed secondary conditions.

The object is assigned to a class from the set of prescribed classes if the membership criterion is above the associated threshold value of the class. In the other case, the object is not assigned to a class from the plurality of prescribed classes if the membership criterion is below the threshold value of the class.

An advantage of the method is that the method determines for each class an individual threshold value that directly takes account of class-typical preconditions by optimizing the evaluation criterion.

The evaluation criterion depending on the threshold values of the classes is a development. In this case, the threshold values feature advantageously directly or indirectly in the evaluation criterion.

Again, the evaluation criterion advantageously includes one of the following specifications:

a) number of errors;

b) detection rate (Recall);

c) detection rate of a detection system (Precision).

The evaluation criterion can focus on specific characteristics of the object to be classified. In particular, the invention accounts for the classification error in the evaluation criterion and optimizes it with respect to specific stipulations.

A further development is providing the evaluation criterion with a condition that requires at least one prescribed value for the evaluation criterion. This accounts for the fact that one of the above-mentioned specifications is allocated a specific value, and this value is accounted for when optimizing the evaluation criterion under the prescribed secondary conditions.

Another development of the invention of the instant application is that an additional secondary condition is specified by prescribing a minimum value of an additional evaluation criterion for all classes. This additional secondary condition also feeds into the optimization of the evaluation criterion by being added to the prescribed secondary conditions.

The secondary conditions are preferably formulated so that the following remain true:

$$\begin{matrix}{k}_{11} + {k}_{12} + … + {k}_{1 M} = 1 \\ {k}_{21} + {k}_{22} + … + {k}_{2 M} = 1 \\ {k}_{N1} + {k}_{N2} + … + {k}_{NM} = 1\end{matrix} \qquad ( 1 )$$

where

kᵢⱼ denotes a result of the class kᵢ which features in the evaluation criterion given the threshold value Tⱼ,

N denotes the number of classes,

M denotes the number of threshold values Tⱼ, and

kᵢⱼ can assume only the values 0 or 1.

In accordance with another feature of the invention, the evaluation criterion is optimized under the secondary conditions by solving a system of linear equations (here, evaluation criterion with prescribed secondary conditions and, if appropriate, additional secondary conditions) by using an LP solver (see, www.wior.uni-karlsruhe.de).

In accordance with another feature of the invention, the method can be used for text classification. When classifying text, a prescribed text is assigned to different (schematic) classes, called “domains”. In this process, a prescribed text can be assigned to a plurality of domains. The decision as to whether the assignment is performed or not is made for each class by comparing the value, determined by the evaluation criterion, for the text with the prescribed threshold value of the domain (class). The result for the text is a membership criterion for each class, and the assignment is performed when the membership criterion is above the threshold value of the respective class. It is particularly the case here that the threshold values for the class are predetermined according to the above-named method.

In accordance with another feature of the invention, a dedicated optimum threshold value is determined for each class.

In accordance with another feature of the invention, a “microaveraged” evaluation is carried out for the classes with the aid of the determined threshold values. This will be examined in detail within the description of the preferred embodiment.

Again, for the purpose of achieving the object of the invention, an configuration is specified for assigning an object to at least one class of a set of prescribed classes, in which a processor unit is provided which is configured in the following way:

a) a membership criterion of the object of a class can be determined for each class;

b) a threshold value can be calculated for each class from the set of classes by optimizing an evaluation criterion under prescribed secondary conditions;

c) the object can be assigned to a class from the set of prescribed classes if the membership criterion is above the threshold value of the class; and

d) the object cannot be assigned to a class from the set of prescribed classes if the membership criterion is below the threshold value of the class.

This configuration is particularly suitable for carrying out the above-described method.

Other features that are considered as characteristic for the invention are set forth in the appended claims.

Although the invention is illustrated and described herein as embodied in a method and configuration for assigning an object to at least one class, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flowchart showing the steps of a method for assigning an object to at least one class from a set of prescribed classes;

FIG. 2 is a table showing the criteria for a text classification; and

FIG. 3 is a block diagram showing a processor unit.

### DESCRIPTION OF THE PREFERRED EMBODIMENTS

In all the figures of the drawing, sub-features and integral parts that correspond to one another bear the same reference symbol in each case.

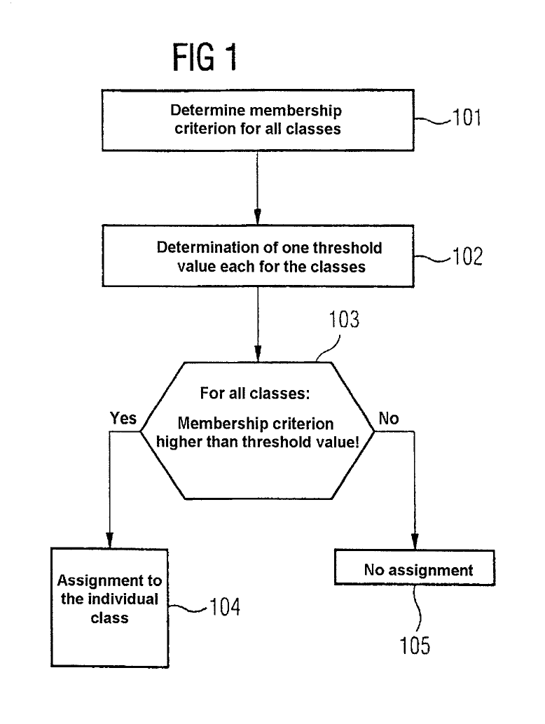

Referring now to the figures of the drawings in detail and first, particularly to FIG. 1 thereof, there is shown a flowchart with steps of a method for assigning an object to at least one class from a set of prescribed classes. In a step 101, a membership criterion is determined for the object to each class. This is intended to indicate whether the object is to be assigned to the respective class. The assignment is performed in general when the membership criterion exceeds a prescribed threshold value for the class. For the purpose of determining a class-dependent threshold value, that is for determining one threshold value for each class, an evaluation criterion is optimized in a step 102 under prescribed secondary conditions. The evaluation criterion is a function of the threshold values of the classes. The optimization produces threshold values for the classes: one threshold value for each class. Step 103 checks whether the membership criterion is higher than the respective class-specific threshold value. If this is the case, the object is assigned to the respective class in accordance with step 104, otherwise no assignment to this class (compare step 105) is made. Alternatively, in accordance with the formulation used here, a deviation criterion can be used instead of the membership criterion. A deviation criterion is understood as merely the negated formulation.

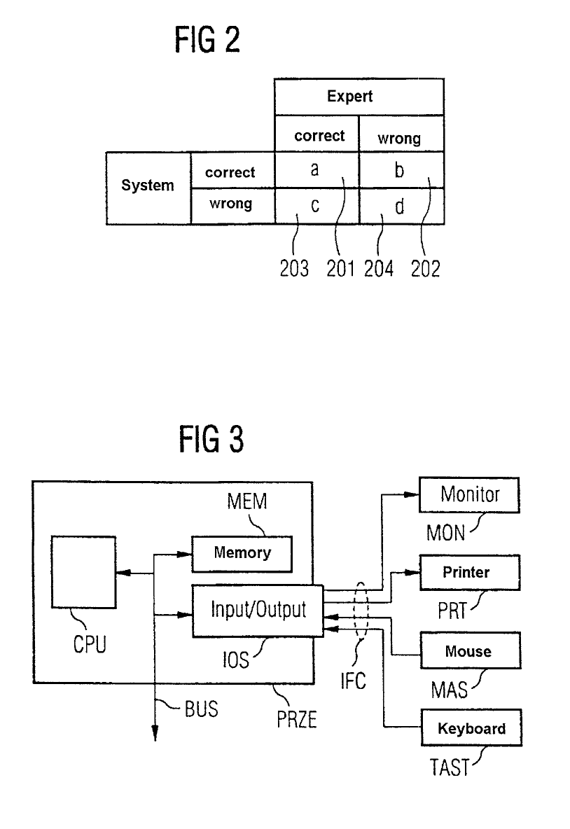

FIG. 2 shows a table with criteria for text classification. Text classification is a possible application for the method of assigning an object to at least one class. Here, prescribed texts are assigned to different classes (domains). Each class belongs to at least one topic. An embodiment includes assigning newspaper texts to one or more topics, for example sport, literature, politics, and/or economics. As set forth above, the evaluation criterion is optimized under prescribed secondary conditions. The evaluation criterion itself can include certain specifications. Some possible specifications are explained in more detail below with the aid of the table of FIG. 2. Boxes 201 to 204 show possible classification states. The box 201 “a” contains all classification decisions correctly taken automatically by the system which are also actually correct, that is assessed by an expert as correct. Box 202 “b” contains a number of all assignments classified as correct by the system which are actually wrong (in accordance with expert opinion). Named in box 203 “c” is the number of such classifications that the system has assigned as wrong that would, however, actually have been correct. Finally, box 204 “d” encompasses all wrong assignments that the system also classified as wrong.

Various specifications can be defined with the aid of the above-named variables. The detection rate (Recall) is defined as the number of correct (recognized) assignments divided by the number of possible assignments:

$$Recall = \frac{a}{a + c} \qquad ( 2 )$$

A detection rate (Precision) is determined by the number of correct assignments divided by the number of all automatic assignments:

$$Precision = \frac{a}{a + b} \qquad ( 3 )$$

An error in the system (Fallout) is determined by the following:

$$Fallout = \frac{b}{b + d} \qquad ( 4 )$$

An error rate is determined by the following:

$$Error rate = \frac{b + c}{a + b + c + d} \qquad ( 5 )$$

The specifications from equation (2) to equation (5) are suitable for specifying the classification quality in the form of a suitable evaluation criterion Q. The evaluation criterion can be determined directly via all classes (“microaveraged” evaluation criterion):

Q(k₁, k₂, . . . , k_{N}) (6)

where N denotes the number of classes kᵢ.

Alternatively, the evaluation criterion firstly can be determined for each class individually, and thereafter be averaged over all classes (“microaveraged” evaluation criterion):

$$\frac{Q ( {k}_{1} ) \_ Q ( {k}_{2} ) + … + Q ( {k}_{N} )}{N} \qquad ( 7 )$$

As already mentioned, it is not to be assumed in general that one and the same threshold value for all classes ensures a sufficiently high quality of assignment (classification). The determination of one threshold value for each class is therefore to be performed such that the classification quality is as high as possible overall. In the case of the “microaveraged” evaluation criterion variant this is performed by determining for each class the threshold value whose value optimizes the evaluation criterion for this class:

$$\frac{Q ( {k}_{1} ) + Q ( {k}_{2} ) + … + Q ( {k}_{N} )}{N} = max ⇔ \\ ⇔ Q ( {k}_{1} ) + Q ( {k}_{2} ) + … + Q ( {k}_{N} ) = max \qquad ( 8 )$$

Equation (8) does not function in the case of the “microaveraged” evaluation criterion. What is being sought here is the following set of threshold values:

{T₁, T₂, . . . , T_{N}} (9)

The threshold values account for an unequal distribution of the classes. If, for example, a class k₁ occurs twice as often as a class k₂, this does not feature in equation (7) and is therefore not sufficiently accounted for overall in the classification quality.

The best set of threshold values (compare equation (9)) is determined by formulating a linear optimization problem and solving it with linear programming (compare LP solver). With the aid of a training set of objects whose classification is known, M different threshold values are used to carry out an evaluation. In this case, kᵢ stands below for the result of class kᵢ in the case of a threshold value Tⱼ, said result featuring in the evaluation criterion Q. The linear optimization problem to be solved is formulated as follows:

Target function:

max Q(k₁₁, k₁₂, . . . , k_{1M}, . . . , k_{N1}, k_{N2}, . . . , k_{NM}) (10)

Secondary conditions:

k₁₁+k₁₂+. . . +k_{1M}=1

k₂₁+k₂₂+. . . +k_{2M}=1 (11).

k_{N1}+k_{N2}+. . . +k_{NM}=1

With the aid of the secondary conditions, only one result per class features in the evaluation criterion Q in each case (kᵢⱼ assumes only the values 0 or 1). The set of the kᵢⱼ, that is to say

{k₁ₐ, k_{2b}, . . . , k_{NZ}} (12)

which maximize the target function, are the solution of the optimization problem. This implies that the optimization of the “microaveraged” evaluation criterion that an optimized result is achieved with the threshold values Tₐ for the class k₁, T_{b} for the class k₂, . . . and T_{z} for the class k_{N}.

This method can also be applied when the quality of the classification system is to be specified by two evaluation criteria Q₁ and Q₂, for example with the aid of Recall and Precision (see above embodiment). In this case, the system of equations is optimized by adding an additional secondary condition:

Target function: F8

max Q(k₁₁, k₁₂, . . . k_{1M}, . . . , k_{N1}, k_{N2}, . . . , k_{NM})

Secondary conditions: F9

k₁₁+k₁₂+. . . +k_{1M}=1

k₂₁+k₂₂+. . . +k_{2M}=1 . . .

k_{N1}+k_{N2}+. . . +k_{NM}=1

Qi(k₁₁, k₁₂, . . . k_{1M}, . . , k_{N1}, k_{N2}, . . . k_{NM})≧X (13),

Where X designates a prescribed minimum value for the evaluation criterion Q₁.

The following definitions are agreed with regard to the above discussion, in particular FIG. 2:

$$\begin{matrix}MIC Recall = \frac{{a}_{1} , {a}_{2} , … , {a}_{N}}{( {a}_{1} , {a}_{2} , … , {a}_{N} ) + ( {c}_{1} , {c}_{2} , … , {c}_{N} )} , & ( 14 ) \\ MIC Precision = \frac{{a}_{1} , {a}_{2} , … , {a}_{N}}{( {a}_{1} , {a}_{2} , … , {a}_{N} ) - ( {b}_{1} , {b}_{2} , … , {b}_{N} )} , & ( 15 ) \\ MAC Recall = \frac{\frac{{a}_{1}}{{a}_{1} + {c}_{1}} + \frac{{a}_{2}}{{a}_{2} + {c}_{2}} + … + \frac{{a}_{N}}{{a}_{N} + {c}_{N}} +}{N} , & ( 16 ) \\ MAC Precision = \frac{\frac{{a}_{1}}{{a}_{1} + {b}_{1}} + \frac{{a}_{2}}{{a}_{2} + {b}_{2}} + … + \frac{{a}_{N}}{{a}_{N} + {b}_{N}} +}{N} , & ( 17 )\end{matrix}$$

MIC denoting “microaveraged”, and MAC denoting “macroaveraged”. The designations aᵢ, bᵢ, cᵢ and dᵢ specify the respective values in the table of FIG. 2, restricted to the classes kᵢ.

A processor unit PRZE is illustrated in FIG. 3. The processor unit PRZE includes a processor CPU, a memory SPE, and an input/output interface IOS. The input/output interface IOS is used in various ways. Via an interface IFC, an output is visualized on a monitor MON via a graphics interface and/or output on a printer PRT. Input is performed via a mouse MAS or a keyboard TAST. The processor unit PRZE also has a data bus BUS The data bus BUS ensures the connection of a memory MEM, the processor CPU, and the input/output interface IOS. It is also possible for additional components to be connected to the data bus BUS, for example additional memories, data storage (hard disk), or scanners.

I claim:

1. A method for assigning an object to at least one class from a set of prescribed classes with a computer, which comprises:
determining a membership criterion of an object for each class;
calculating a threshold value for each class from a set of prescribed classes by optimizing an evaluation criterion under prescribed secondary conditions;
assigning the object to a class from the set of prescribed classes if the membership criterion is above the threshold value of the class; and
not assigning the object to a class from the set of prescribed classes if the membership criterion is below the threshold value of the class.

2. The method according to claim 1, in which the evaluation criterion is a function of the threshold values of the set of classes.

3. The method according to claim 1, wherein the evaluation criterion is a number of errors.

4. The method according to claim 1, wherein the evaluation criterion is a detection rate.

5. The method according to claim 1, wherein the evaluation criterion is a detection system.

6. The method according to claim 1, wherein the evaluation criterion is provided with a condition requiring at least one prescribed value for the evaluation criterion.

7. The method according to claim 1, which further comprises specifying an additional secondary condition by prescribing a minimum value of an additional evaluation criterion for all of the classes.

8. The method according to claim 1, in which the secondary conditions are formulated so that it holds that:
k₁₁+k₁₂+. . . +k_{1M}=1
k₂₁+k₂₂+. . . +k_{2M}=1 . . .
k_{N1}+k_{N2}+. . . +k_{NM}=1
where
kᵢⱼ denotes the result of the class kᵢ which features in the evaluation criterion given the threshold value Tⱼ,
N denotes the number of classes,
M denotes the number of threshold values Tⱼ, and
kᵢⱼ can assume only the values 0 or 1.

9. The method according to claim 1, which further comprises optimizing the evaluation criterion under the secondary conditions by solving a system of linear equations with an LP solver.

10. The method according to claim 1, which further comprises determining a dedicated optimum threshold value for each class.

11. The method according to claim 1, which further comprises optimizing a microaveraged evaluation with the aid of the respective threshold values for each class of the set of classes.

12. A method for classifying text by assigning an object to at least one class from a set of prescribed classes with a computer, which comprises:
determining a membership criterion of an object for each class;
calculating a threshold value for each class from a set of prescribed classes by optimizing an evaluation criterion under prescribed secondary conditions;
assigning the object to a class from the set of prescribed classes if the membership criterion is above the threshold value of the class; and
not assigning the object to a class from the set of prescribed classes if the membership criterion is below the threshold value of the class.

13. The method according to claim 12, in which the classes in the text classification are domains.

14. A configuration for assigning an object to at least one class from a set of prescribed classes, comprising a processor unit determining a membership criterion of an object of a class for each class of a set of classes, calculating a threshold value for each class of said set of classes by optimizing an evaluation criterion under prescribed secondary conditions, assigning the object to a class from said set of prescribed classes if said membership criterion is above said threshold value of said class, and not assigning the object to a class from said set of classes if said membership criterion is below said threshold value of said class.
